(19) United States
(12) Patent Application Publication
(10) Pub. No.: US 2025/0132457 A1
(43) Pub. Date: Apr. 24, 2025

(54) VEHICLE HAVING POSITIVE VENTILATION FOR A HIGH VOLTAGE BATTERY PACK FOR THERMAL RUNAWAY GAS EVACUATION AND DILUTION

(71) Applicant: FCA US LLC, Auburn Hills, MI (US)

(72) Inventors: Uday K. Mahakali, Novi, MI (US); Sreekanth Surapaneni, Oakland, MI (US); Venkata K. M. Chagarlamudi, Rochester Hills, MI (US)

(21) Appl. No.: 18/491,128

(22) Filed: Oct. 20, 2023

(51) Int. Cl. H01M 50/375; H01M 10/613; H01M 10/625; H01M 10/63; H01M 10/6563; H01M 50/249; H01M 50/317

(52) U.S. Cl. CPC H01M 50/375; H01M 10/613; H01M 10/625; H01M 10/63; H01M 10/6563; H01M 50/249; H01M 50/317; H01M 2220/20

(57) ABSTRACT

A battery thermal management system including an air induction device for drawing air to a battery pack, a controller, a valve that opens to permit the air to enter the battery pack, and a temperature sensor for generating signals indicative of a temperature within the battery pack. Upon receipt of a signal from the temperature sensor that is indicative of the temperature within the housing being above a predetermined threshold, the controller is configured to instruct the air induction device to begin drawing the air, and instruct the valve to open to permit the air to enter the battery pack and cool each of the battery cells and dilute the battery gases generated by the plurality of battery cells.

### FIELD

The present disclosure relates to a vehicle having positive ventilation for a high voltage battery pack for thermal runaway gas evacuation and dilution.

### BACKGROUND

This section provides background information related to the present disclosure which is not necessarily prior art.

Vehicles with electric propulsion systems are becoming increasingly more common. Some electrically propelled vehicles include an electric drive motor at each wheel of the vehicle, and some electrically propelled vehicles include a front electric drive motor for rotating the front wheels of the vehicle and a rear electric drive motor for rotating the rear wheels of the vehicle. In either case, the electric drive motors receive power from a battery pack that includes a plurality of battery cells therein. Example battery cells include lithium-ion battery cells and lithium-metal battery cells.

Lithium-ion and lithium-metal battery cells sometimes undergo a process called thermal runaway during failure conditions. Thermal runaway may result in a rapid increase of battery cell temperature accompanied by the release of various gases, which in some cases may be flammable. These flammable gases may be ignited by the hot temperature of the battery, which may result in a fire. Accordingly, in the event of a thermal runaway, it is desirable that the vehicle include features that assist in preventing, or at least substantially minimizing, the ignition of various gases that are generated during the thermal runaway.

### SUMMARY

This section provides a general summary of the disclosure and is not a comprehensive disclosure of its full scope or all of its features.

According to an aspect of the present disclosure, there is provided a vehicle that includes a battery pack including a housing having a plurality of battery cells contained therein, the housing including a plurality of vents for discharging battery gases generated by the plurality of battery cells; a battery thermal management system configured to cool each of the battery cells and dilute the battery gases generated by the plurality of battery cells, the battery thermal management system including an inlet pipe in communication with an atmosphere located external to the battery pack; an air induction device for drawing air from the atmosphere located external to the battery pack into the inlet pipe; at least one outlet pipe connected to the inlet pipe downstream from the air induction device and in communication with an interior of the housing; at least one first valve, the at least one first valve located between the at least one outlet pipe and the interior of the housing; at least one first temperature sensor for generating signals indicative of a temperature within the housing; and a controller in communication with each of the air induction device, the at least one first valve, and the at least one first temperature sensor, wherein upon receipt of a signal from the at least one first temperature sensor that is indicative of the temperature within the housing being above a predetermined threshold, the controller is configured to instruct the air induction device to begin drawing the air into the inlet pipe and outlet pipe connected to the inlet pipe, and instruct the at least one first valve located between the at least one outlet pipe and the interior of the housing to open to permit the air to enter the battery pack and cool each of the battery cells and dilute the battery gases generated by the plurality of battery cells before a mixture of the air and battery gases exit the battery pack through at least one of the plurality of vents.

According to the aspect, the battery pack is divided into a plurality of battery modules that each include a number of the plurality of the battery cells, and each of the battery modules is isolated from each other.

According to the aspect, a plurality of outlet pipes are connected to the inlet pipe at a location downstream from the air induction device, and each outlet pipe is connected to a respective battery module.

According to the aspect, the vehicle further includes a plurality of the first valves, and each first valve is located between a respective outlet pipe that is connected to a respective battery module.

According to the aspect, the vehicle further includes a plurality of the first temperature sensors, and each first temperature sensor is in communication with a respective battery module.

According to the aspect, upon receipt of a signal from one of the plurality of first temperature sensors that is indicative of a temperature within a respective battery module being above the predetermined threshold, the controller is configured to instruct the air induction device to begin drawing the air into the inlet pipe and the plurality of outlet pipes connected to the inlet pipe, and instruct the each of the plurality of first valves located between each respective outlet pipe and an interior of a respective battery module to open to permit the air to enter the respective battery modules and cool each of the battery cells and dilute the battery gases generated by the plurality of battery cells before a mixture of the air and battery gases exit the battery pack through at least one of the plurality of vents.

According to the aspect, upon receipt of a signal from one of the plurality of first temperature sensors that is indicative of a temperature within a respective battery module being above the predetermined threshold, the controller is configured to instruct the air induction device to begin drawing the air into the inlet pipe and the plurality of outlet pipes connected to the inlet pipe, and instruct the first valve of the plurality of valves that is located between the outlet pipe connected to the respective battery module and an interior of the respective battery module to open to permit the air to enter the respective battery module and cool each of the battery cells and dilute the battery gases generated by the plurality of battery cells before a mixture of the air and battery gases exit the respective battery module through at least one of the plurality of vents.

According to the aspect, each battery module includes a conduit located within an interior of the battery module that is attached to a respective outlet pipe with one of the valves located therebetween.

According to the aspect, the conduit includes a plurality of outlet ports that are directed at a respective battery cell of the number of battery cells located in the respective battery module.

According to the aspect, upon receipt of a signal from one of the plurality of first temperature sensors that is indicative of a temperature within a respective battery module being above the predetermined threshold, the controller is configured to instruct the air induction device to begin drawing the air into the inlet pipe and the plurality of outlet pipes connected to the inlet pipe, and instruct the one first valve that is located between the outlet pipe connected to the respective battery module and the conduit located within the interior of the respective battery module to open to permit the air to enter the conduit and be directed to the respective battery cells through the outlet ports to cool each of the battery cells and dilute the battery gases generated by the plurality of battery cells before a mixture of the air and battery gases exit the respective battery module through at least one of the plurality of vents.

According to the aspect, each battery cell of the number of battery cells in the respective battery module includes a dedicated second temperature sensor that generates a signal indicative of a temperature of the battery cell to which it is dedicated, each of the second temperature sensors being in communication with the controller.

According to the aspect, each of the outlet ports includes a second valve in communication with the controller that, based on an instruction received from the controller, is configured to open and permit the air to exit the outlet in a direction toward the respective battery cell.

According to the aspect, upon receipt of a signal from one of the plurality of second temperature sensors that is indicative of the temperature of its dedicated battery cell being above the predetermined threshold, the controller is configured to instruct the air induction device to begin drawing the air into the inlet pipe and the plurality of outlet pipes connected to the inlet pipe, instruct the first valve of the plurality of valves that is located between the outlet pipe connected to the respective battery module and an interior of the respective battery module to open to permit the air to enter the conduit of the respective battery module, and instruct the second valve located proximate the dedicated battery cell to open to permit the air to be directed toward the dedicated battery cell and cool the dedicated battery cell and dilute the battery gases generated by the dedicated battery cell before a mixture of the air and battery gases exit the respective battery module through at least one of the plurality of vents.

According to the aspect, the air induction device is a fan.

According to the aspect, the plurality of vents are in communication with a manifold that collects the battery gases emitted from the plurality of vents.

According to the aspect, the manifold is in communication with an exhaust pipe that directs the battery gases collected by the manifold in a direction away from the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic representation of a vehicle including a battery thermal management system according to a principle of the present disclosure;

FIGS. 2 and 3 are perspective views of an example battery that may be used in the vehicle illustrated in FIG. 1; and

FIG. 4 is a schematic representation of another battery thermal management system according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

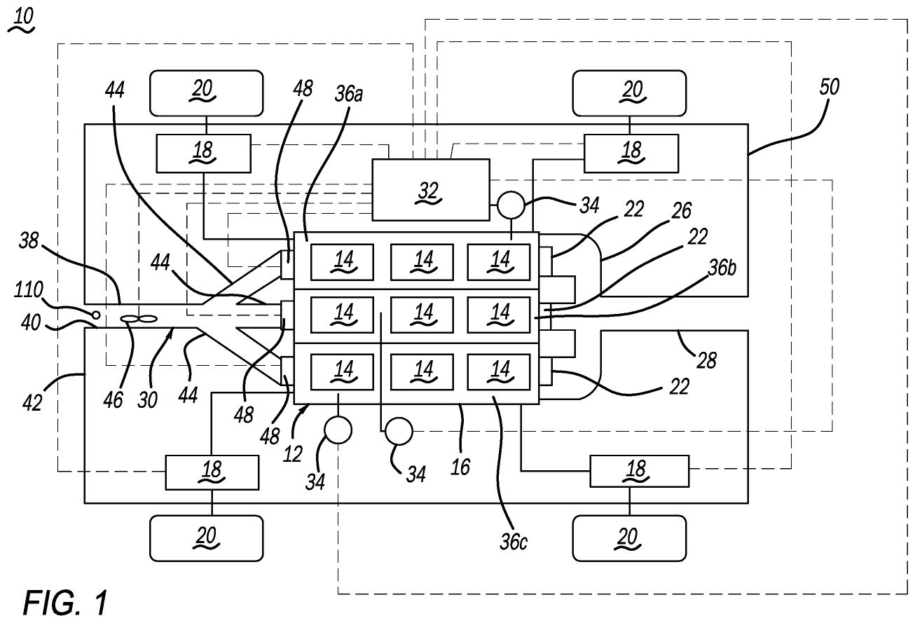

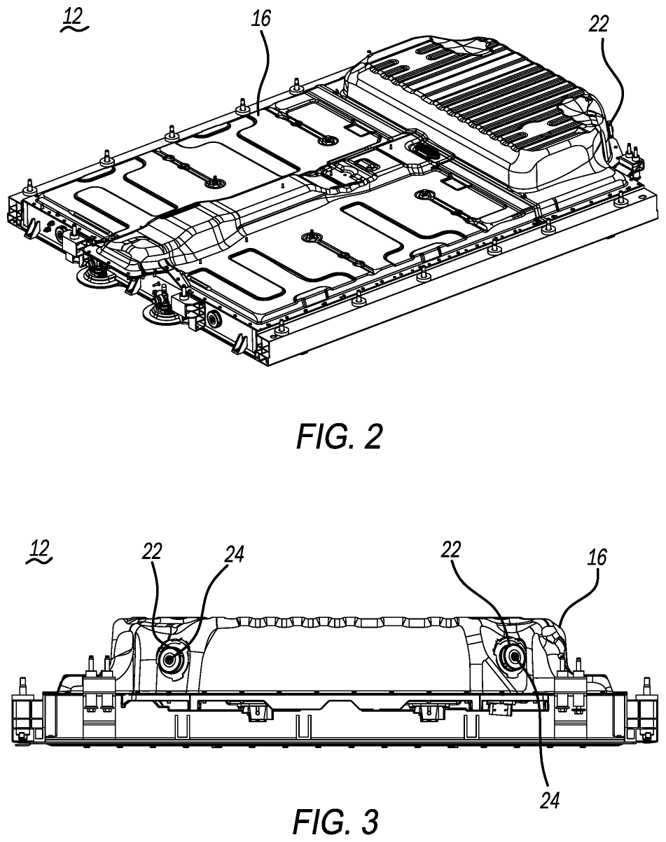

FIG. 1 is a schematic representation of a vehicle 10 according to a principle of the present disclosure. In the illustrated embodiment, vehicle 10 may be an electrically powered vehicle including a battery pack 12 that includes a plurality of battery cells 14. Example battery cells 14 include lithium-ion battery cells, lithium-metal battery cells, and combinations thereof. It should be understood, however, that other types of battery cells 14 known to one skilled in the art may be used, without limitation. Battery pack 12 includes a housing 16 that encases each of the battery cells 14. Housing 16 is preferably formed of a rigid metal material (e.g., steel, aluminum, and the like) that is resistant to puncture and is non-flammable. An example battery pack 12 is illustrated in FIGS. 2 and 3.

Still referring to FIG. 1, a plurality of electric drive modules 18 are in electrical communication with battery pack 12. Electric drive modules 18 may electrically actuate the wheels 20 of vehicle 10. While a plurality of electric drive modules 18 are illustrated, it should be understood that vehicle 10 may include a single electric drive module 18 for driving, for example, the front pair of wheels 20 or the rear pair of wheels 20. Alternatively, the pair of front wheels 20 may be driven by one electric drive module 18 and the rear pair of wheels 20 may be driven by another electric drive module 18. Regardless of the configuration selected, it should be understood that electric drive module 18 receives a voltage or current from battery pack 12 that is utilized by the electric drive module 18 to drive the wheels 20 of the vehicle 10.

As noted above, battery cells 14 may sometimes undergo a process called thermal runaway during failure conditions of the battery cell(s) 14. Thermal runaway may result in a rapid increase of battery cell temperature accompanied by the release of various gases, which in some cases may be flammable. Example gases that may be released during a thermal runaway event include hydrogen (H₂), carbon monoxide (CO), carbon dioxide (CO₂), and various hydrocarbons including, but not limited to, methane, ethane, ethylene, acetylene, propane, cyclopropane, and butane. As these gases are released and the temperature of battery pack 12 increases, the pressure within battery pack 12 also increases. Housing 16 of battery pack 12, therefore, includes a plurality of vents 22, which are best shown in FIGS. 2 and 3, that permit the pressure and gases to escape housing 16.

Vents 22 may each include a valve 24 (FIGS. 2 and 3) that may be a one-way valve and opens upon a predetermined pressure threshold being generated within housing 16. For example, if the pressure within housing 16 reaches 100 millibars the valves 24 may open and permit the gases within housing 16 to exit the battery pack 12. In the embodiment illustrated in FIG. 1, vents 22 are in communication with a collection manifold 26 that communicates with a battery gas tailpipe 28. Manifold 26 is configured to collect the battery gases emitted from vents 22 during a thermal runaway event and communicate the battery gases into tailpipe 28 before the battery gases exit the tailpipe to the atmosphere.

Vehicle 10 may include a battery thermal management system 30 that is controlled by a controller 32. Battery thermal management system 30 may include a plurality of temperature sensors 34 that are in communication with controller 32, and that are each configured to generate signals indicative of a temperature of various modules 36a, 36b, and 36c located within housing 16 of battery pack 12. Each of the modules 36a, 36b, and 36c include a plurality of the battery cells 14, and each of the modules 36a, 36b, and 36c may be isolated from each other. The term “isolated” is intended to mean that each module is sealed relative to another module such that, if one module (e.g., 36a) includes battery cell(s) 14 that fail and begins to undergo thermal runaway, the battery gases emitted during the thermal runaway event are prevented from reaching the other modules (e.g., 36b and 36c). As can be seen in FIG. 1, there are three temperature sensors 34 and each temperature sensor 34 is in communication with a single module. Of course, one skilled in the art will readily acknowledge and appreciate that battery pack 12 may include more modules than the three illustrated that are each monitored by a respective temperature sensor. Based on the signal indicative of temperature received from temperature sensor(s) 34, controller 32 is configured to cooling of battery pack 12 using battery thermal management system 30, as will be described in more detail below.

More particularly, battery thermal management system 30 is configured to cool battery pack 12 using fresh air that may be drawn from an exterior of vehicle 10. As can be seen in FIG. 1, battery thermal management system 30 includes an inlet pipe 38 that is in communication with the atmosphere. Inlet pipe 38 may include an inlet 40 that may be located, for example, at a front 42 of vehicle 10. Specifically, inlet 40 may be provided near a grille (not shown) of vehicle. Other locations for inlet 40, however, are contemplated. For example, inlet 40 may be present near one of the A-pillars (not shown) of vehicle 10, on a side of the vehicle 10, or any other location selected by one skilled in the art. Regardless of the location of inlet 40, the primary aspect to keep in mind is that inlet 40 is in communication with atmosphere and able to permit ambient air located exterior to the vehicle to enter inlet pipe 38.

Inlet pipe 38 may be in communication with a plurality of outlet pipes 44 that each communicate with a respective module 36a, 36b, and 36c. In addition, inlet pipe 38 may include an air induction device or fan 46 that is in communication with controller 32 for drawing ambient air into inlet pipe 38 and then pushing the drawn ambient air into each of the outlet pipes 44. A valve 48 may be positioned between each outlet pipe 44 and each module 36a, 36b, and 36c. Valves 48 may be one-way valves that prevent fluids (e.g., gases) from escaping battery pack 12, while permitting the ambient air to enter the modules 36a, 36b, and 36c during a thermal runaway event. Alternatively, as illustrated, valves 48 may be electrically operated (e.g., solenoid) valves that communicate with controller 32 and only open to permit the ambient air to enter the modules 36a, 36b, and 36c upon receipt of an instruction from controller 32. Air induction device or fan 46 should be designed for drawing the ambient air into battery thermal management system 30 at a high velocity, and for avoiding pressure drops that may occur in system when valves 48 are opened.

Now operation of battery thermal management system 30 will be described. During operation of battery pack 12, temperature sensors 34 monitor the temperature in each module 36a, 36b, and 36c and transmit signals indicative of the temperatures in each of the modules 36a, 36b, and 36c to controller 32. If at least one of the temperature sensors 34 transmits a signal of a temperature that may be indicative of a thermal runaway event in one of the modules 36a, 36b, and 36c to controller 32, controller 32 is configured to send an instruction to air induction device 46 to begin drawing ambient air into inlet pipe 38.

In addition, controller 32 is configured to transmit an instruction to each of the valves 48 to open and permit the air drawn by air induction device 46 to pass therethrough into each respective module 36a, 36b, and 36c. At this time, the ambient air will intermix with any battery gases being emitted by battery cells 14 to cool the battery gases as well as dilute the battery gases. Moreover, if the pressure within battery pack 12 is above the predetermined threshold (e.g., 100 millibars), valves 24 of vents 22 will open and permit the mixture of ambient air and cooled/diluted battery gases to exit housing 16 of battery pack 12 and enter manifold 26 and tailpipe 28 before being expelled to the atmosphere at a rear 50 of vehicle 10. By cooling and diluting the battery gases generated during thermal runaway, the battery gases will be less harmful to any occupants that may be attempting to exit vehicle, as well as less dangerous relative to other components of the vehicle 10 that could potentially ignite when exposed to the hot battery gases, which can have temperatures up to 500 degrees C. Further, because the battery gases are diluted by the ambient air, any combustible species that may be part of the battery gases may be less likely to combust.

It should be understood that in the above-described embodiment, a battery cell or cells 14 in one module (e.g., 36b) may be undergoing thermal runaway, while the battery cells 14 located in the other modules (e.g., 36a and 36c) are not undergoing thermal runaway. Notwithstanding, by opening each of the valves 48 to permit ambient air to enter each of the modules 36a, 36b, and 36c simultaneously, battery cells 14 that may be located in module(s) (e.g., 36a and 36c) that are not undergoing thermal runaway may be cooled in an effort to prevent or at least minimize the battery cells 14 located therein from undergoing thermal runaway.

The present disclosure, however, should not be limited to an embodiment where each of the valves 48 are opened at the same time. Indeed, as noted above, each of the modules 36a, 36b, and 36c are isolated from each other and monitored by a respective temperature sensor 34. Thus, it is contemplated that if a potential thermal runaway event is detected by a temperature sensor 34 in communication with one of the modules (e.g., 36b), controller 32 is configured to instruct only the valve 48 that is in communication with that respective module (e.g., 36b) to open and permit the ambient air to enter that respective module (e.g., 36b), while maintaining the valves 48 in communication with the other modules (e.g., 36a and 36c) in the closed position.

Moreover, while FIG. 1 illustrates a battery pack 12 having a plurality of modules 36a, 36b, and 36c that are isolated from each other, it should be understood that battery pack 12 is not necessarily divided into isolated modules 36a, 36b, and 36c. In contrast, housing 16 may carry a plurality of the battery cells 14 without any dividers therebetween. In such a case, inlet pipe 38 would not divide into a plurality of outlet pipes 44, but rather be directly connected to housing 16 via a single valve 48 and the air drawn by fan 46 that passes through valve 48 would enter housing 16 and disperse therethrough before exiting vents 22 and entering manifold 26 and tailpipe 28.

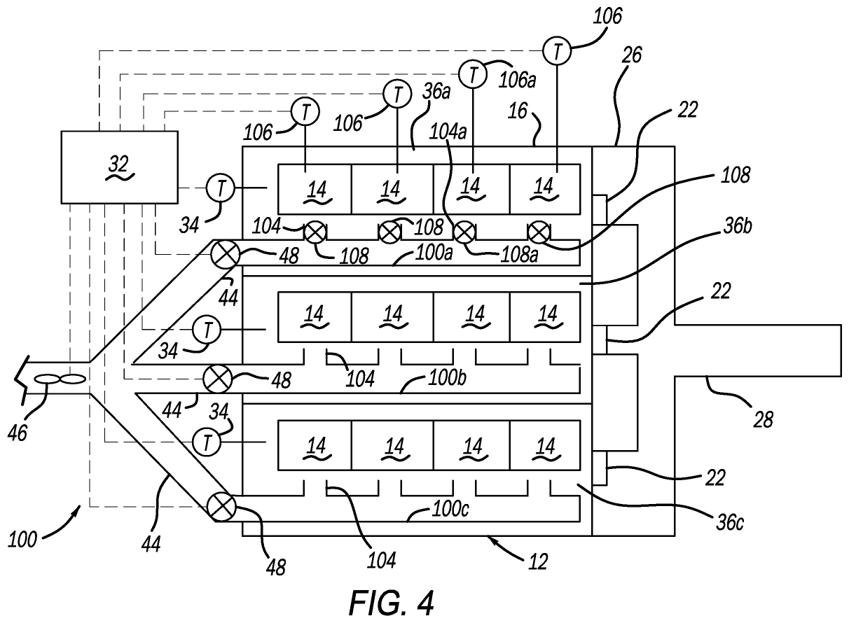

Now referring to FIG. 4, another example battery thermal management system 100 is illustrated. Thermal management system 100 is similar to battery thermal management system 30 illustrated in FIG. 1 and may be used in place of thermal management system 30 in vehicle 10. Thus, features of vehicle 10 illustrated in FIG. 1 are not illustrated in FIG. 4 and further description of the features of vehicle 10 will be omitted. In addition, it should be understood that features that are common to each of battery thermal management system 30 and battery thermal management system 100 utilize the same reference numbers. For example, each battery thermal management system 30 and 100 includes a battery pack 12 having a housing 16; a plurality of battery cells 14; vents 22 having one-way valves 24 (FIGS. 2 and 3); a manifold 26; tailpipe 28; a controller 32; temperature sensors 34 in communication with a respective module 36a, 36b, and 36c and in communication with controller 32; an air induction device 46 such as a fan for drawing ambient air; and outlet pipes 44 that each include a valve 48 that, when open, permit the ambient air drawn by air induction device 46 to enter housing 16 and/or a respective module 36a, 36b, and 36c.

The primary difference between battery thermal management system 100 and battery thermal management system 30 is that each outlet pipe 44 is connected to a respective conduit 100a, 100b, and 100c with valve 48 located therebetween. Each conduit 100a, 100b, and 100c is located within a respective module 36a, 36b, and 36c and extends along a length of each respective module 36a, 36b, and 36c. Moreover, each conduit 100a, 100b, and 100c includes a plurality of outlet ports 104 that are configured to direct the air that enters conduits 100a, 100b, and 100c to a respective battery cell 14. With this configuration, as the ambient air enters each respective module 36a, 36b, and 36c, the ambient air can be focused at a respective battery cell 14 to provide localized cooling to each battery cell 14 rather than simply being dispersed throughout each respective module 36a, 36b, and 36c. In this regard, as the air exits the outlet ports 104, the air will be directed to the respective battery cell 14 as a jet of cold air (at least in comparison to a temperature within the respective module 36a, 36b, and 36c) that can quickly cool the respective battery cell 14.

In lieu of or in addition to each module 36a, 36b, and 36c having a temperature sensor 34 associated therewith that generates signals indicative of temperature within the module, it should be understood that each respective battery cell 14 can also be monitored by a dedicated temperature sensor 106 that generates signals indicative of temperature for the battery cell 14 to which it is assigned. Sensors 106 may be in communication with controller 32. While only battery cells 14 located in module 36a are illustrated as including such a sensor 106, it should be understood that each cell 14 in each module 36a, 36b, and 36c can include such a sensor 106.

Moreover, it should be understood that if each cell 14 includes a dedicated sensor 106, each outlet port 104 can also include a valve 108 located therein that is also in communication with controller 32. While only one valve 108 is illustrated as being in communication with controller 32, it should be understood that each valve 108 may be in communication with and opened and closed by controller 32. Further, while only outlet ports 104 located in module 36a are illustrated as having valves 108, it should be understood that each outlet port 104 in each module 36a, 36b, and 36c can include a valve 108 in communication with controller 32. With such a configuration, when one of the temperature sensors (e.g., 106a) identifies a particular battery cell (e.g., 14a) in a particular module (e.g., 36a) that may be undergoing a thermal runaway event, controller 32 can instruct air induction device 46 to begin drawing ambient air into inlet pipe 38 and outlet pipe 44 in communication with module 36a. Controller 32 can also simultaneously instruct valve 48 in communication with module 36a to open to permit the ambient air to enter conduit 100a. Finally, controller 32 can instruct the valve (e.g., 108a) located in outlet port (e.g., 104a) associated with the battery cell (e.g., 14a) exhibiting the unusually elevated temperature to open and direct a jet of cold air at the battery cell 14a to cool battery 14a and potentially mitigate a thermal runaway event by destabilizing any flames that may be present. Thus, thermal management system 100 provides a more sophisticated approach to thermally managing temperatures of the battery cells 14 of battery pack 12.

In each of the above-described embodiments, it should be understood that the battery thermal management systems 30 and 100 should be configured to prevent the collection of debris, water, snow, and the like from collecting in inlet pipe 38 or outlet pipes 44. Although not illustrated, a drain hole 110 can be located upstream from air induction device 46, or an air filter (not shown) can be located upstream from air induction device 46.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a battery pack including a housing having a plurality of battery cells contained therein, the housing including a plurality of vents for discharging battery gases generated by the plurality of battery cells;
a battery thermal management system configured to cool each of the battery cells and dilute the battery gases generated by the plurality of battery cells, the battery thermal management system including:
an inlet pipe in communication with an atmosphere located external to the battery pack;
an air induction device for drawing air from the atmosphere located external to the battery pack into the inlet pipe;
at least one outlet pipe connected to the inlet pipe downstream from the air induction device and in communication with an interior of the housing;
at least one first valve, the at least one first valve located between the at least one outlet pipe and the interior of the housing;
at least one first temperature sensor for generating signals indicative of a temperature within the housing; and
a controller in communication with each of the air induction device, the at least one first valve, and the at least one first temperature sensor,
wherein upon receipt of a signal from the at least one first temperature sensor that is indicative of the temperature within the housing being above a predetermined threshold, the controller is configured to instruct the air induction device to begin drawing the air into the inlet pipe and outlet pipe connected to the inlet pipe, and instruct the at least one first valve located between the at least one outlet pipe and the interior of the housing to open to permit the air to enter the battery pack and cool each of the battery cells and dilute the battery gases generated by the plurality of battery cells before a mixture of the air and battery gases exit the battery pack through at least one of the plurality of vents.

2. The vehicle according to claim 1, wherein the battery pack is divided into a plurality of battery modules that each include a number of the plurality of the battery cells, each of the battery modules being isolated from each other.

3. The vehicle according to claim 2, wherein a plurality of outlet pipes are connected to the inlet pipe at a location downstream from the air induction device, and each outlet pipe is connected to a respective battery module.

4. The vehicle according to claim 3, further comprising a plurality of the first valves, and each first valve is located between a respective outlet pipe that is connected to a respective battery module.

5. The vehicle according to claim 4, further comprising a plurality of the first temperature sensors, and each first temperature sensor is in communication with a respective battery module.

6. The vehicle according to claim 5, wherein upon receipt of a signal from one of the plurality of first temperature sensors that is indicative of a temperature within a respective battery module being above the predetermined threshold, the controller is configured to instruct the air induction device to begin drawing the air into the inlet pipe and the plurality of outlet pipes connected to the inlet pipe, and instruct the each of the plurality of first valves located between each respective outlet pipe and an interior of a respective battery module to open to permit the air to enter the respective battery modules and cool each of the battery cells and dilute the battery gases generated by the plurality of battery cells before a mixture of the air and battery gases exit the battery pack through at least one of the plurality of vents.

7. The vehicle according to claim 5, wherein upon receipt of a signal from one of the plurality of first temperature sensors that is indicative of a temperature within a respective battery module being above the predetermined threshold, the controller is configured to instruct the air induction device to begin drawing the air into the inlet pipe and the plurality of outlet pipes connected to the inlet pipe, and instruct the first valve of the plurality of valves that is located between the outlet pipe connected to the respective battery module and an interior of the respective battery module to open to permit the air to enter the respective battery module and cool each of the battery cells and dilute the battery gases generated by the plurality of battery cells before a mixture of the air and battery gases exit the respective battery module through at least one of the plurality of vents.

8. The vehicle according to claim 4, wherein each battery module includes a conduit located within an interior of the battery module that is attached to a respective outlet pipe with one of the valves located therebetween.

9. The vehicle according to claim 8, wherein the conduit includes a plurality of outlet ports that are directed at a respective battery cell of the number of battery cells located in the respective battery module.

10. The vehicle according to claim 9, wherein upon receipt of a signal from one of the plurality of first temperature sensors that is indicative of a temperature within a respective battery module being above the predetermined threshold, the controller is configured to instruct the air induction device to begin drawing the air into the inlet pipe and the plurality of outlet pipes connected to the inlet pipe, and instruct the one first valve that is located between the outlet pipe connected to the respective battery module and the conduit located within the interior of the respective battery module to open to permit the air to enter the conduit and be directed to the respective battery cells through the outlet ports to cool each of the battery cells and dilute the battery gases generated by the plurality of battery cells before a mixture of the air and battery gases exit the respective battery module through at least one of the plurality of vents.

11. The vehicle according to claim 9, wherein each battery cell of the number of battery cells in the respective battery module includes a dedicated second temperature sensor that generates a signal indicative of a temperature of the battery cell to which it is dedicated, each of the second temperature sensors being in communication with the controller.

12. The vehicle according to claim 11, wherein each of the outlet ports includes a second valve in communication with the controller that, based on an instruction received from the controller, is configured to open and permit the air to exit the outlet in a direction toward the respective battery cell.

13. The vehicle according to claim 12, wherein upon receipt of a signal from one of the plurality of second temperature sensors that is indicative of the temperature of its dedicated battery cell being above the predetermined threshold, the controller is configured to instruct the air induction device to begin drawing the air into the inlet pipe and the plurality of outlet pipes connected to the inlet pipe, instruct the first valve of the plurality of valves that is located between the outlet pipe connected to the respective battery module and an interior of the respective battery module to open to permit the air to enter the conduit of the respective battery module, and instruct the second valve located proximate the dedicated battery cell to open to permit the air to be directed toward the dedicated battery cell and cool the dedicated battery cell and dilute the battery gases generated by the dedicated battery cell before a mixture of the air and battery gases exit the respective battery module through at least one of the plurality of vents.

14. The vehicle according to claim 1, wherein the air induction device is a fan.

15. The vehicle according to claim 1, wherein the plurality of vents are in communication with a manifold that collects the battery gases emitted from the plurality of vents.

16. The vehicle according to claim 1, wherein the manifold is in communication with an exhaust pipe that directs the battery gases collected by the manifold in a direction away from the vehicle.
